(19) United States
(12) Patent Application Publication
(10) Pub. No.: US 2002/0176188 A1
(43) Pub. Date: Nov. 28, 2002

(54) Offset cancellation of charge pump based phase detector

(75) Inventors: Michael A. Ruegg, Santa Cruz, CA (US); Sasan Cyrusian, Scotts Valley, CA (US)

Correspondence Address: Matthew J Kelly, Brinks Hofer Gilson & Lione, P O Box 10395, Chicago, IL, 60610, US

(73) Assignee: Infineon Technologies N.A. Inc.

(21) Appl. No.: 09/865,406

(22) Filed: May 25, 2001

(51) Int. Cl. G11B 5/09

(52) U.S. Cl. 360/46

(57) ABSTRACT

A offset cancellation of charge pump based phase detector is disclosed. The methods and circuits disclosed cancel inherent with a phase detector and imbalanced charge pumps. The offset cancellation includes detecting the phase detector and the charge pump offset with a calibration signal and a reference voltage source, and applying a calibration current to cancel the phase detector and charge pump offset.

### BACKGROUND

Computer hard disk drives, also known as fixed disk drives or hard drives, have become a de facto data storage standard for computer systems and are making inroads into consumer electronics as well. Their proliferation can be directly attributed to their low cost, high storage capacity and reliability, in addition to wide availability, low power consumption, fast data transfer speeds and decreasing physical size.

Disk drives typically consist of one or more rotating magnetic platters encased within an environmentally controlled housing. The disk drive further includes electronics and mechanics for reading and writing data and interfacing with other devices. Read/write heads are positioned in proximity of the platters, typically towards each face, to record and read data on the platters. The hard drive electronics are coupled with the read/write heads and include components to control the position of the heads and generate or sense the electromagnetic fields representing data on the platters. The electronics encode data received from a host device, such as a personal computer, and translate the data into magnetic encodings, which are written onto the platters. When the host device requests data, the electronics locate the desired data on the platters, sense the magnetic encodings representing that data, and translate the encodings into the binary digital information. Error detection and correction algorithms may also be applied to ensure accurate storage and retrieval of data.

Advancements in the read/write head and the methods of interpreting magnetic encodings have been made. A traditional hard drive has several read/write heads that interface with the several magnetic platters and the hard drive electronics. The read/write heads detect and record the encoded data as areas of magnetic flux. Data bits, consisting of binary 1's and 0's, are encoded by the presence or absence of flux reversals. A flux reversal is a change in the magnetic flux in two contiguous areas of the disk platter. Data is read using method as “Peak Detection” by which a voltage peak imparted in the read/write head is detected when a flux reversal passes the read/write head. However, increasing storage densities, which require reduced peak amplitudes, better signal discrimination and higher platter rotational speeds are pushing the peaks in closer proximity. Thus, peak detection methods are becoming increasingly complex.

Magneto-resistive (“MR”) read/write heads have been developed. MR read/write heads have increased sensitivity to sense smaller amplitude magnetic signals and provide increased signal discrimination, addressing some of the problems with increasing storage densities. In addition, technology known as Partial Response Maximum Likelihood (“PRML”) has been developed to further address the desire to provide increased data storage densities. PRML is an algorithm implemented in the disk drive electronics to interpret the magnetic signals sensed by the read/write heads. PRML based disk drives read the analog waveforms generated by the magnetic flux reversals stored on the disk. Instead of looking for peak values, PRML based drives digitally sample this analog waveform (the “Partial Response”) and use advanced signal processing technologies to determine the bit pattern represented by that wave form (the “Maximum Likelihood”). This technology, combined with MR heads, have permitted further increases in data storage densities. PRML technology tolerates more noise in the magnetic signals, permitting use of lower quality platters and read/write heads, which also increases manufacturing yields and lowers costs.

With many different drives available, hard drives are typically differentiated by factors such as cost/megabyte of storage, data transfer rate, power requirements and form factor (physical dimensions) with the bulk of competition based on cost. With most competition between hard drive manufacturers coming in the area of cost, there is a need for enhanced hard drive components which prove cost effective in increasing supplies and driving down manufacturing costs all while increasing storage capacity, operating speed, reliability and power efficiency.

For example, PRML based read/write electronics may include a phase detector that indirectly controls a Voltage Controlled Oscillator (“VCO”) via a CMOS designed charge pump configured. The phase detector generates control signals that may include an offset component. In addition, the charge pump arranged may have an inherent offset due to imbalance between in one or more transistors of the charge pump. The phase detector offset coupled with the charge pump offset may result in inadvertent operation of the VCO. The Offset may be minimized with charge pump transistors having a relatively large source and having relatively large voltage supplies. However, charge pumps designs based on CMOS technology having a relatively smaller supply voltage have been developed. With these designs, the offset inherent with the charge pump and the phase detector needs to be minimized to maximize the operating range for the charge pump.

Accordingly, there is a need in the art for offset cancellation for a phase detector and a charge pump.

### SUMMARY

An offset cancellation for a charge pump based phase detector for a partial response, maximum likelihood (“PRML”) read/write channel is disclosed. A PRML read/write channel includes a Phase locked Loop (“PLL”) having a charge pump circuit controlled by a phase detector circuit. The charge pump and phase detector circuits control a Voltage Controlled Oscillator (“VCO”) used for timing read and write operations in the PRML read/write channel. The offset cancellation for a charge pump based phase detector provides a circuit configured to cancel an offset voltage in a digital phase detector and in a charge pump.

One embodiment of an offset cancellation for a charge pump based phase detector includes a reference voltage source, a pulse generator, a comparator, and a logic circuit. The reference voltage source generates a reference voltage having a potential substantially equal to a potential at a loop filter node when the phase locked loop is in a settled state. The pulse generator applies a calibration signal to the charge pump. The calibration signal propagates through the charge pump to a loop filter node, and creates an offset voltage at the loop filter node. The comparator determines the difference between the reference voltage and the offset voltage and generates a control signal corresponding to the difference. The control signal is communicated with the logic circuit which controls an offset current source coupled with the loop filter node to provide an offset current to the loop filter node. The offset current applied at the loop filter node cancels the offset voltage imparted on the loop filter node.

One embodiment of a method for offset cancellation for a charge pump based phase detector includes the acts of canceling offset of a charge pump based phase detector, the method comprising the acts of generating a reference voltage associated with a settled state output for the phase locked loop; applying a calibration signal to the phase detector, the calibration signal propagating an offset voltage to a loop filter node; and applying the calibration current at the loop filter node to cancel the output offset voltage, the calibration current corresponding to a difference between the reference voltage and the offset voltage.

The foregoing discussion of the summary of the invention is provided only by way of introduction. Nothing in this section should be taken as a limitation on the claims, which define the scope of the invention. Additional objects and advantages of the present invention will be set forth in the description that follows, and in part will be obvious from the description, or may be learned by practice of the present invention. The objects and advantages of the present invention may be realized and obtained by means of the instrumentalities and combinations particularly pointed out in the claims.

### BRIEF DESCRIPTION OF SEVERAL VIEWS OF THE DRAWINGS

FIG. 1A depicts block diagram of an exemplary hard drive coupled with a host device.

FIG. 1B depicts a block diagram of read/write channel for use with a hard drive.

FIG. 2 is a schematic diagram illustrating an offset cancellation circuit; and

FIG. 3 illustrates a flowchart according to one embodiment of a method for canceling offset.

### DETAILED DESCRIPTION

The embodiments described herein relate to a PRML based read/write channel device. The read/write channel is coupled with the read/write heads of the hard drive. Herein, the phrase “coupled with” is defined to mean directly connected to or indirectly connected through one or more intermediate components. Such intermediate components may include both hardware and software based components. The read/write channel converts digital data from the host device into electrical impulses to control the read/write head to magnetically record data to the hard disk. During read operations, the read/write channel receives an analog waveform magnetically sensed by the read/write heads and converts that waveform into the digital data stored on the drive.

The illustrated embodiments provide an offset cancellation for a charge pump based phase detector. A phase detector offset that is propagated to a loop filter node as a component of a charge pump current is cancelled according to the embodiments described herein.

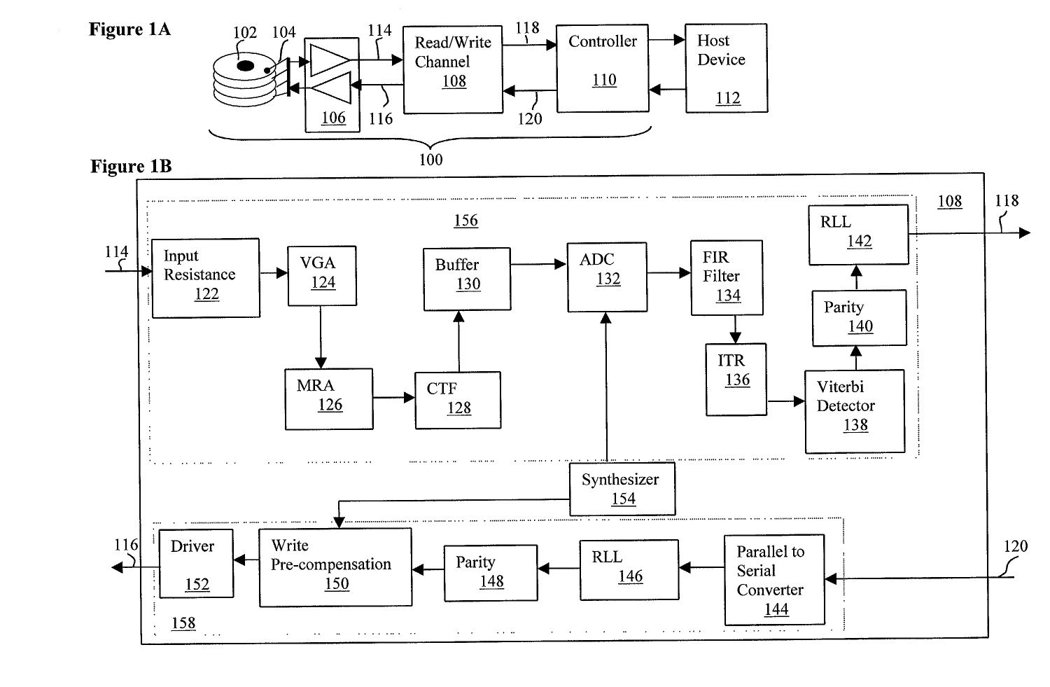

The present invention will be explained with reference to accompanied FIGS. 1 through 3. Referring now to FIG. 1A, a block diagram for a hard drive 100 coupled with a host device 112 is shown. For clarity, some components, such as a servo/actuator motor control, are not shown. The drive 100 includes the magnetic surfaces and spindle motor 102, the read/write heads and actuator assembly 104, pre-amplifiers 106, a read/write channel 108 and a controller 110. The pre-amplifiers 106 are coupled with the read/write channel 108 via interfaces 114 and 116. The controller 110 interfaces with the read/write channel 108 via interfaces 118 and 120.

For reads from the hard disk 100, the host device 112 provides a location identifier that identifies the location of the data on the disk drive, e.g. a cylinder and sector address. The controller 110 receives this address and determines the physical location of the data on the platters 102. The controller 110 then moves the read/write heads into the proper position for the data to spin underneath the read/write heads 104. As the data spins underneath the read/write head 104, the read/write head 104 senses the presence or absence of flux reversals, generating a stream of analog signal data. This data is passed to the pre-amplifiers 106 which amplify the signal and pass the data to the read/write channel 108 via the interface 114. As will be discussed below, the read/write channel receives the amplified analog waveform from the pre-amplifiers 106 and decodes this waveform into the digital binary data that it represents. This digital binary data is then passed to the controller 110 via the interface 118. The controller 110 interfaces the hard drive 100 with the host device 112 and may contain additional functionality, such as caching or error detection/correction functionality, intended to increase the operating speed and/or reliability of the hard drive 100.

For write operations, the host device 112 provides the controller 110 with the binary digital data to be written and the location, e.g. cylinder and sector address, of where to write the data. The controller 110 moves the read/write heads 104 to a designated location and sends the binary digital data to be written to the read/write channel 108 via interface 120. The read/write channel 108 receives the binary digital data, encodes it and generates analog signals which are used to drive the read/write head 104 to impart the proper magnetic flux reversals onto the magnetic platters 102 representing the binary digital data. The generated signals are passed to the pre-amplifiers 106 via interface 116 which drive the read/write heads 104.

Referring to FIG. 1B, an exemplary read/write channel 108 is shown that supports Partial Response Maximum Likelihood (“PRML”) encoding technology for use with the hard drive 100 of FIG. 1A. For clarity, some components have been omitted. The read/write channel 108 may be implemented as an integrated circuit using a complementary metal oxide semiconductor (“CMOS”) process for transistors having an effective channel length of 0.18 micron. It will be appreciated that other process technologies and feature sizes may be used and that the circuitry disclosed herein may be further integrated with other circuitry comprising the hard disk electronics such as the hard disk controller logic. As was described, the read/write channel 108 converts between binary digital information and the analog signals representing the magnetic flux on the platters 102. The read/write channel 108 is divided into two main sections, the read path 156 and the write path 158.

The write path 158 includes a parallel-to-serial converter 144, a run-length-limited (“RLL”) encoder 146, a parity encoder 148, a write pre-compensation circuit 150 and a driver circuit 152. The parallel to serial converter 144 receives data from the host device 112 via the interface 120 eight bits at a time. The converter 144 serializes the input data and sends a serial bit stream to the RLL encoder 146. The RLL encoder 146 encodes the serial bit stream into symbolic binary sequences according to a run-length limited algorithm for recording on the platters 102. The exemplary RLL encoder may use a 32/33 bit symbol code to ensure that flux reversals are properly spaced and that long runs of data without flux reversals are not recorded. The RLL encoded data is then passed to the parity encoder 148 that adds a parity bit to the data. In the exemplary parity encoder 148, odd parity is used to ensure that long run's of 0's and 1's are not recorded due to the magnetic properties of such recorded data. The parity-encoded data may be subsequently treated as an analog signal rather than a digital signal. The analog signal is passed to a write pre-compensation circuit 150 that dynamically adjusts the pulse widths of the bit stream to account for magnetic distortions in the recording process. The adjusted analog signal is passed to a driver circuit 152 that drives the signal to the pre-amplifiers 106 via interface 116 to drive the read/write heads 104 and record the data. The exemplary driver circuit 152 includes a pseudo emitter coupled logic (“PECL”) driver circuit that generates a differential output to the pre-amplifiers 106.

The read path 156 includes an attenuation circuit/input resistance 122, a variable gain amplifier (“VGA”) 124, a magneto-resistive asymmetry linearizer (“MRA”) 126, a continuous time filter (“CTF”) 128, a buffer 130, an analog to digital converter (“ADC”) 132, a finite impulse response (“FIR”) filter 134, an interpolated timing recovery (“ITR”) circuit 136, a Viterbi algorithm detector 138, a parity decoder 140, and a run-length-limited (“RLL”) decoder 142. The amplified magnetic signals sensed from the platters 102 by the read/write head 104 are received by the read/write channel 108 via interface 114. The analog signal waveform representing the sensed magnetic signals is first passed through an input resistance 122 that is a switching circuit to attenuate the signal and account for any input resistance. The attenuated signal is then passed to a VGA 124 that amplifies the signal. The amplified signal is then passed to the MRA 126 that adjusts the signal for any distortion created by the recording process. Essentially, the MRA 126 performs the opposite function of the write-pre-compensation circuit 150 in the write path 158. The signal is next passed through the CTF 128, which may be essentially a low pass filter, to filter out noise. The filtered signal is then passed to the ADC 132 via the buffer 130 that samples the analog signal and converts it to a digital signal. The digital signal is then passed to a FIR filter 134 and then to a timing recovery circuit 136.

The timing recovery circuit 136 may be connected (not shown in the figure) to the FIR filter 134, the MRA 126 and the VGA 124 in a feedback orientation to adjust these circuits according to the signals received to provide timing compensation. The exemplary FIR filter 134 may be a 10 tap FIR filter. The digital signal is then passed to the Viterbi algorithm detector 138 that determines the binary bit pattern represented by the digital signal using digital signal processing techniques. The exemplary Viterbi algorithm detector 138 uses a 32 state Viterbi processor. The binary data represented by the digital signal is then passed to the parity decoder 140, which removes the parity bit, and then to the RLL decoder 142. The RLL decoder 142 decodes the binary RLL encoding symbols to the actual binary data. This data is then passed to the controller 110 via the interface 118.

The read/write channel 108 further includes a clock synthesizer 154. The exemplary clock synthesizer 154 includes a phase locked loop (“PLL”) (not shown) for synchronizing read operations for the read/write channel.

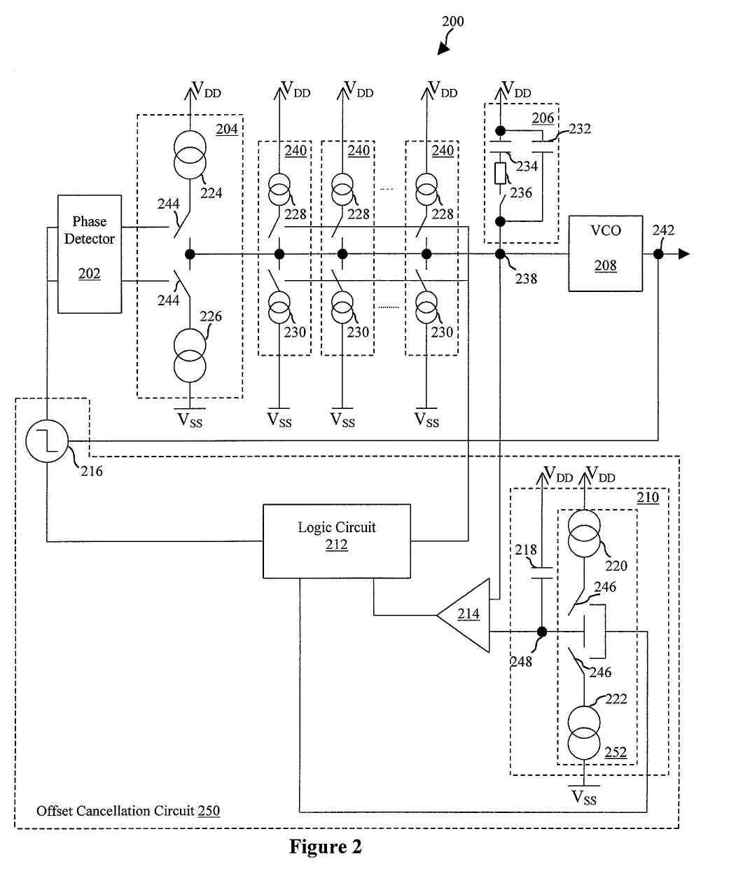

Referring to FIG. 2, an exemplary portion of a PLL circuit 200 is shown. The circuit 200 includes a phase detector 202, a charge pump 204, a loop filter 206, a voltage controlled oscillator (“VCO”) 208, and an offset cancellation circuit 250. The circuit further includes one or more delta charge pumps 240. The phase detector 202 compares two input signals, determines a delay between the input signals and generates control signals correlating to the delay. In response to the control signals, the charge pump 204 charges or discharges the loop filter 206 by providing positive or negative current, respectively, at a loop filter node 238. The VCO 208 provides a variable frequency clock signal at VCO output node 242 in response to the potential received at the loop filter node 238.

The charge pump 204 generates current for charging and discharging the loop filter 206. The charge pump 204 may be any conventionally designed charge pump configured to provide current to a loop filter node. In one embodiment, the charge pump is described in commonly assigned U.S. patent application Ser. No. ______, titled “LOW VOLTAGE CHARGE PUMP FOR PHASE LOCKED LOOP,” by Michael A. Ruegg et al., filed on May 25, 2001 reference of which is incorporated herein in its entirety. The charge pump 204 includes an up current source 224 selectively coupled with the loop filter 206 via a switch device 244. The charge pump 204 further includes a down-current source 226 selectively coupled with the loop filter 206 via the switch device 244.

The loop filter 206 may include a loop filter resistor device 236, a first capacitor 234 and a second capacitor 232. The loop filter resistor device 236 may be coupled in series with the first capacitor 234. The loop filter resistor device 236 and the first capacitor 234 are further coupled in parallel to the second capacitor 232. The loop filter 206 may be configured to maintain a potential at a lop filter node 238. Charge stored by the first capacitor 234 may be increased or decreased by the charge pump 204. Over a voltage range, the voltage/current relationship for the loop filter node 238 can be characterized by the following linear expression:

z*Δv/Δt=I eq. 1

where “z” is a capacitive impedance of the loop filter, “Δv/Δt” is change in the loop filter node potential with respect to time, and “I” is current through the loop filter. The impedance “z” is substantially constant and the potential at the loop filter node 238 may be increased based on current provided at the loop filter node 238. Similarly, the potential at the loop filter node 238 may be decreased based on current drawn at the loop filter node 238. Accordingly, the up-current source 224 charges the loop filter node 226 by providing a positive current to the loop filter 206 and the down-current source 226 discharges the loop filter node 208 by drawing a negative current from the loop filter 206.

The VCO 208 may be coupled with the loop filter 206 at the loop filter node 238. The VCO 208 generates a clock signal for synchronizing read and write operations for a PRML based hard disk drive. The clock signal has a variable frequency that correlates to the potential at the loop filter node 238.

The phase detector 202 includes a first phase detector input and a second phase detector input. The phase detector 202 has an output coupled with the charge pump 204. The phase detector 202 controls the charge pump 204 to charge or discharge the potential at the loop filter node 238. The phase detector determines to charge or discharge the potential at the loop filter node 238 based on a delay between input signals at the first phase detector input and the second phase detector input. In a conventional PLL circuit, a clock signal from the VCO 208 output node 242 is provided in a feedback loop to the first phase detector input and a reference signal is provided at the second phase detector input. The phase detector 202 compares the delay between the clock signal and the reference signal. Based on the delay between the signals, the phase detector 202 generates a control signal to the charge pump 204. When the phase detector 202 determines that there is a delay between the clock signal and the reference signal, the phase detector 202 controls the charge pump 204 to regulate the potential at the loop filter node 238 to adjust the VCO clock signal frequency in synchronization with the reference signal.

When the phase detector 202 determines that there is substantially no delay between input signals, the phase detector 202 generates control signals to synchronize the current sources 224 and 226. When the current sources 224 and 226 are synchronized, current in the up-current source 224 is substantially the same as current in the down-current source 226 and no current is sent to the loop filter 206.

When the phase detector 202 determines a delay between phases of the input signals, the phase detector 202 generates control signals to operate the charge pump to charge or discharge the loop filter 206, based on the delay. When the phase detector 202 determines to charge the loop filter 238, the phase detector 202 switches the current sources 224 and 226 so that the current through the up-current source 224 is greater than current through the down-current source 226 and current difference flows to the loop filter 206. Current flow to the loop filter node 238 increases the potential at the loop filter node 238. Similarly, when the phase detector 202 discharges the loop filter, the phase detector 202 switches the current sources 224 and 226 so that current through the down-current source 226 is greater than current through the up-current source 224 and current flows from the loop filter 206, decreasing the potential at the loop filter node 238.

The control signals generated by the phase detector 202 may include a phase detector offset. The phase detector offset is a component of the control signals that causes the control signal to be out of calibration with the charge pump 204. By way of example, when there is no delay between input signals to the phase detector 202, the phase detector generates control signals that may include an offset component. The offset component switches the current sources 224 and 226 and current inadvertently flows at the loop filter node 238 charging or discharging of the loop filter node 206.

The charge pump introduces a charge pump offset current due to an imbalance between the current sources 224 and 226. In conventional designs, the current sources 224 and 226 are fabricated using PMOS and NMOS transistors arranged in a CMOS configuration. An imbalance between the PMOS and NMOS transistors creates a charge pump offset current at the loop filter node 238. The offset current caused by the charge pump 204 may be coupled with the offset created by the phase detector 202.

The offset cancellation circuit 250 may be configured to cancel the offset created by the phase detector 202 and the charge pump 204. The offset cancellation circuit 250 includes a reference voltage source 210, a comparator 214, a logic circuit 212, and a pulse generator 216. The offset cancellation circuit 250 may be coupled with the phase detector 202 and the loop filter node 238. The offset cancellation circuit 250 may be further coupled with the delta charge pumps 240. The offset cancellation circuit 250 determines the phase detector offset and the charge pump offset at the loop filter node 238 and controls the delta charge pumps 240 to cancel offset current at the loop filter node 238.

The comparator 214 has a first comparator input, a second comparator input, and a comparator output. The comparator generates a logic control signal at the comparator output based on a potential difference between the first comparator input and the second comparator input. The first comparator input may be coupled with the reference voltage source 210 at a reference voltage node 248, the second comparator input may be coupled with the loop filter 206 at the loop filter node 238. The comparator output may be coupled with the logic circuit 212. The comparator 214 communicates a logic control signal to the logic circuit 212 based on a voltage difference between the reference voltage node 248 and the loop filter node 238.

The reference voltage source 210 generates a reference voltage at a reference voltage node 248. The reference voltage is communicated with the comparator 214 at the first comparator input. The reference voltage source 210 may include a reference voltage capacitor 218, and a charge pump 252 having an up-current source 220, a down-current source 222. The reference voltage capacitor 218 is coupled with the reference voltage node 248. The up-current source 220 and the down current source 222 may be selectively coupled to the reference voltage node 248 through a switch device 246. The reference voltage at the reference voltage node 248 is provided as a charge stored by the reference voltage capacitor 218. The up-current source 220 provides current to the reference voltage capacitor 218 to increase the charged stored in the reference voltage capacitor 218 and thereby increase the reference voltage. The down-current source 222 draws current from the reference voltage capacitor 218 to decrease the charge stored in the reference voltage capacitor 218 and thereby decrease the reference voltage.

The logic circuit 212 may be coupled with the reference voltage source 210, the output of the comparator 214, the loop filter node 238, and the pulse generator 216. The logic circuit 212 controls the reference voltage source 210 to switch the up-current source 220 and the down-current source 222 to generate a desired reference voltage at the reference voltage node 248.

In one embodiment, the logic circuit 212 controls the voltage reference source 210 to generate a reference voltage substantially equal to a voltage at the loop filter node 238 associated with a settled state for the PLL circuit 200. At power up, the potential at the loop filter node 238 is communicated with the second comparator input. The comparator 214 evaluates the potential difference between a potential at the loop filter node 238 and the reference voltage node 248. The comparator 214 generates the logic control signal which is communicated with the logic circuit 212. When the comparator determines that the reference voltage at the reference voltage node 248 is not substantially equal to the voltage at the loop filter node 238, the logic circuit 212 switches the current sources 220, 222 to charge or discharge the reference voltage capacitor 218 towards the voltage at the loop filter node 238. When the comparator determines that the voltage at the reference voltage node 248 is substantially equal to the loop filter node voltage, the logic circuit 212 controls the reference voltage source 210 to terminate charging and discharging of the reference voltage capacitor 218.

The pulse generator 216 includes a pulse generator output coupled with the first phase detector input and with the second phase detector input. The pulse generator 216 generates a pulse wave at the pulse generator output. The pulse wave includes between 75 and 150 continuous square voltage pulses of approximately 1.8 V. It is preferred that the pulse wave includes approximately 100 pulses. In one embodiment, the pulse generator 216 comprises the VCO 208 and the pulse wave comprises the VCO clock signal.

The logic circuit 212 couples the pulse generator output with the first input and the second input of the phase detector. Because an identical signal is communicated with the first phase detector input and the second phase detector, there is no substantial delay determined by the phase detector 202 and the phase detector offset is isolated at the phase detector output and is communicated as a control signal to the charge pump 204 to switch the current sources 224 and 226. The charge pump 204 propagates the phase detector offset in conjunction with a charge pump offset current to the loop filter node 238. The phase detector offset and the charge pump offset current charge or discharge the second capacitor 232 with an offset voltage.

With the second capacitor 232 charged with the offset voltage, the comparator 214 determines a difference between the reference voltage at the charged reference voltage capacitor 218 and the offset voltage at the loop filter node 238. The comparator 214 communicates a logic control signal to logic circuit 212 associated with the difference between the offset voltage and the reference voltage.

In response to the logic control signal, the logic circuit 212 switches a delta charge pump 240 to compensate for the difference between the offset voltage and the reference voltage. The delta charge pumps 240 include a delta up-current source 228 and a delta down-current source 230. In an embodiment, the charge pumps 228 and 230 are CMOS transistors. In another embodiment, the up-current source 228 may include a pull-up resistive device and the down-current source may include a pull-down resistive device. The delta charge pumps are configured to generate a delta current relative to the charge pump 204 at the loop filter node. The current generated by an individual delta charge pump 240 is expected to cancel a discrete offset voltage at the loop filter node. One or more delta charge pumps 240 may be coupled with the loop filter node 238. In an embodiment, six delta charge pumps are coupled with the loop filter node 238.

By way of example, when the voltage at the loop filter node 238 includes an offset voltage greater than the reference voltage at the reference voltage capacitor 218, the comparator 214 communicates a logic control signal to the logic circuit 212 indicating to the logic circuit 212 to discharge the loop filter 206. When the logic circuit 212 determines that the loop filter 206 is to be discharged, the logic circuit 212 switches a delta charge pump 240 so that the down-current source 230 carries more current than an up-current source 228. Accordingly, the delta charge pump 240 generates offset cancellation current in response to the logic circuit 212 to cancel the offset voltage at the loop filter node. The delta charge pump remains switched in the configuration set by the logic circuit 212 so that the offset of the phase detector 202 and the charge pump 204 remain cancelled for further operations.

In one embodiment, the offset cancellation circuit 250 may be further configured to recalibrate the phase detector 202 and the charge pump 204 to cancel any remaining offset subsequent to switching a delta charge pump 240. In an exemplary embodiment, the logic circuit may be configured to repeat control of the reference voltage source 210 to match the voltage at the loop filter node 238, re-couple the pulse generator 216 to the first phase detector input and the second phase detector input to propagate any further offset to the loop filter node 238, re-compare the voltage at the loop filter node 238 with the reference voltage, and switch a delta current source 240 to cancel an offset voltage that may have propagated to the loop filter node 238. The offset current circuit 200 repeat calibration of the phase detector 202 and the charge pump 204 for each delta charge pump 240 that is coupled to the loop filter node 238, with a single delta charge pump 240 being switched during respective calibrations.

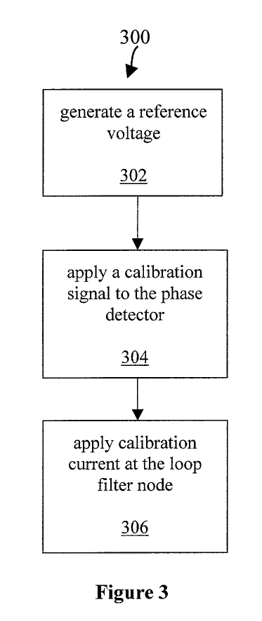

Referring to FIG. 3, a flowchart for an exemplary method for canceling offset in a charge pump based phase detector is shown. The method includes the acts of generating 302 a reference voltage associated with a settled state output for the phase detector; applying 304 a calibration signal to the phase detector; and applying 306 a calibration current at the loop filter node to cancel the output offset voltage. The act of applying 304 a calibration signal includes propagating an offset current resulting from applying the calibration signal to a loop filter node. The act of applying 306 a calibration current includes selectively coupling a delta charge pump to the loop filter node. The delta charge pump may be configured to generate the calibration current corresponding to a difference between the reference voltage and the offset voltage.

The act of generating 302 a reference voltage includes charging a capacitor with a charge pump to a potential substantially equal to the settled state output potential at the loop filter node. It is preferred that the act of applying 304 a calibration signal includes applying approximately one hundred 1.8 V clock pulses to the phase detector and the act of applying 308 a calibration current includes the acts of comparing the reference voltage to the offset voltage and determining a level for the calibration current in response to the comparison. The act of applying 308 a calibration current further includes controlling a calibration charge pump to provide the calibration current at the loop filter node.

In an one embodiment, the method for canceling offset includes repeating the acts of generating 302 a reference voltage; applying 304 a calibration signal; and applying 306 a calibration current to cancel any further offset at the loop filter node.

As heretofore mentioned, an offset cancellation of charge pump based phase detector capable of canceling the offset of a phase detector and a charge pump can be obtained. In particular the present embodiment is applicable to charge pump based phase detector used in a PLL for a PRML read/write channel design.

The method is not limited to the circuits as shown in FIGS. 1-3 and described above. Various implementations of the method for offset cancellation of charge pump based phase detector can be realized that are within the scope of the present invention. All of the components for the offset cancellation of charge pump based phase detector may be integrated with the PRML read/write channel on a single integrated circuit semiconductor chip. Alternatively, some or all of the components of the circuit according to the principles of the present invention may be implemented in one or more integrated circuits external to a PRML read/write channel design.

While particular embodiments of the present invention have been shown and described, modifications may be made. It is therefore intended in the appended claims, including all equivalents, cover all such changes and modifications.

1. A phase locked loop for use in a PRML based read/write circuit, comprising:
a loop filter operative to maintain a potential at a loop filter node responsive to current flow at the loop filter node;
a charge pump coupled with the loop filter and operative to control current at the loop filter node;
a phase detector operative to provide a control signal to the charge pump where the control signal is responsive to a phase difference in input signals; and
an offset cancellation circuit operative to cancel an offset in the control signal.

2. The phase locked loop of claim 1, wherein the offset cancellation circuit comprises:
a variable reference voltage source operative to provide a reference voltage associated with a settled state of the phase locked loop;
a comparator coupled with the reference voltage source and with the loop filter node, the comparator operative to provide a control signal responsive to a potential difference between the reference voltage source and the loop filter node;
an offset cancellation charge pump circuit operative to provide calibration current to the loop filter node; and
a logic circuit operative to provide a calibration signal to the phase detector.

3. The phase locked loop of claim 2, wherein the variable reference voltage source comprises:
a capacitor having a reference voltage node; and
a reference voltage charge pump operative to charge and discharge the reference voltage node.

4. The phase locked loop of claim 3, wherein the logic circuit is operative to control the variable reference voltage source in response to the control signal.

5. The phase locked loop of claim 4, wherein the logic circuit is operative to control the offset current circuit in response to the control signal.

6. The phase locked loop of claim 5, wherein the charge pump comprises:
an up-current source operative to increase the potential at a loop filter node; and
a down-current source operative to decrease the potential at the loop filter node.

7. The phase locked loop of claim 6, wherein the offset cancellation charge pump comprises:
at least one offset up-current source operative to provide a delta current to the loop filter node to increase a delta potential at the loop filter node; and
at least one offset down-current source operative to draw delta current from the loop filter node to decrease a delta potential at the loop filter node.

8. The phase locked loop of claim 7, wherein the offset up current source comprises a pull-up resistive device and the offset down current source comprises a pull-down resistive device.

9. The phase locked loop of claim 8, wherein the reference voltage charge pump comprises:
a reference voltage up-current source operative to provide current to the reference voltage node to increase a potential at the reference voltage node; and
a reference voltage down-current source operative to draw current from the reference voltage node to decrease the potential at the reference voltage node.

10. A hard disk drive comprising the phase locked loop of claim 8.

11. An offset cancellation circuit for use in a charge pump circuit, comprising:
a reference voltage source operative to generate a reference voltage associated with a settled state voltage for a phase locked loop;
a pulse generator operative to provide a calibration signal to the phase detector, the calibration signal propagating an offset voltage to a loop filter node;
a comparator operative to generate a control signal associated with a voltage difference between the reference voltage and the offset voltage at the loop filter node; and
a logic circuit operative to control an offset current source responsive to the control signal, the offset current source coupled with the loop filter node.

12. The offset cancellation circuit of claim 11, wherein the calibration signal comprises a voltage pulse signal having continuous square voltage pulses.

13. The offset cancellation circuit of claim 12, wherein the logic circuit is operative to control the voltage reference source responsive to the control signal.

14. The offset cancellation circuit of claim 13, wherein the pulse generator is operative to provide the calibration signal to the phase detector that is coupled with the charge pump, the phase detector propagating the offset voltage to the loop filter node.

15. The offset cancellation circuit of claim 14, wherein the pulse generator comprises a voltage controlled oscillator, and wherein the logic circuit is operative to selectively couple an output of the voltage controlled oscillator to the phase detector.

16. A charge pump circuit comprising the offset cancellation circuit of claim 15.

17. A method of canceling an offset in a charge pump based phase detector, the method comprising the acts of:
generating a reference voltage associated with a settled state for a phase locked loop;
applying a calibration signal to a phase detector, the calibration signal propagating an offset voltage to a loop filter node; and
applying a calibration current at the loop filter node to cancel the output offset voltage, the calibration current corresponding to a difference between the reference voltage and the offset voltage.

18. The method of claim 17, wherein the act of generating a reference voltage comprises charging a capacitor to a potential substantially equal to the settled state output potential at the loop filter node.

19. The method of claim 18, wherein the act of applying a calibration signal comprises applying a 1.8 Volt clock signal to the phase detector, the clock signal having continuous clock pulses.

20. The method of claim 19, wherein the act of applying a calibration current comprises:
comparing the reference voltage to the offset voltage at the loop filter node;
determining a level for the calibration current responsive to (i); and
controlling a calibration charge pump to provide the calibration current at the loop filter node.
